(19) United States
(12) Patent Application Publication
(10) Pub. No.: US 2003/0083412 A1
(43) Pub. Date: May 1, 2003

(54) Rubber compounds

(76) Inventors: Hans-Detlef Luginsland, Koln (DE); Andrea Korch, Frechen (DE); Robert Wissner, Frankfurt (DE)

Correspondence Address: SMITH, GAMBRELL & RUSSELL, LLP, 1850 M STREET, N.W., SUITE 800, WASHINGTON, DC, 20036, US

(21) Appl. No.: 10/178,995

(22) Filed: Jun. 25, 2002

(30) Foreign Application Priority Data
Jun. 25, 2001 (DE) 101 30 500.1

(51) Int. Cl. C08K 5/24

(52) U.S. Cl. 524/265

(57) ABSTRACT

Rubber compounds, containing

(a) a rubber or a mixture of rubbers

(b) at least one filler and

(c) a processing agent corresponding to the general formula (I)

R¹—O—R² (I).

They are produced by mixing the rubber or the mixture of rubbers, the filler and the processing agent corresponding to formula I in a mixing unit. The composition can be used in mouldings.

The present invention relates to rubber compounds, a process for their production and their use.

EP 0 761 734 discloses rubber compounds containing at least one polymer selected from the diene rubbers, 5-100 phr finely divided silica, 0-80 phr carbon black, optionally 0.2-10 phr silane coupling agent and 0.5-20 phr of at least one non-aromatic viscosity-reducing substance, which is based on the elements C, H and 0, has a portion containing at least 2 hydroxyl groups, which are present as 1,2- or 1,3-diol, and a portion consisting of at least 2 chemically bonded C atoms, with neither these nor their chemically bonded neighbouring C atoms being substituted by O.

A disadvantage of the known rubber compounds is that they have poor dynamic properties, in particular tan δ 60° C. values. It is therefore an object of the present invention to provide a rubber compound which exhibits an excellent processing behaviour (low viscosity, short vulcanization times) and improved vulcanizate data (for example, high reinforcement factor, low permanent set and low hysteresis loss).

### SUMMARY OF THE INVENTION

The above and other objects of the invention can be achieved by a rubber compound, which is characterized in that this contains

(a) a rubber or a mixture of rubbers,

(b) at least one filler and

(c) a processing agent corresponding to the general formula (I)

R¹—O—R² (I),

wherein R¹, R² may be identical or different and consist of hydroxy-substituted C₁ to C₈ alkyl groups, with the proviso that the hydroxy-substituted alkyl groups R¹ and R², separately or together, do not have a region containing at least 2 hydroxyl groups which are present as 1,2- or 1,3-diols.

The processing agent cannot contain a region consisting of at least 2 chemically bonded C atoms, with neither these nor their chemically bonded neighbouring C atoms being substituted by O.

### DETAILED DESCRIPTION OF INVENTION

In accordance with the present invention, the rubber used may be natural rubber and/or synthetic rubbers. Preferred synthetic rubbers are described, for example, in: W. Hofmann, Kautschuktechnologie, Genter Verlag, Stuttgart 1980. They may include, inter alia,

polybutadiene (BR)

polyisoprene (IR)

styrene-butadiene copolymers having styrene contents of 1 to 60, preferably 5 to 50 wt. % (SBR)

isobutylene-isoprene copolymers (IIR)

butadiene-acrylonitrile copolymers having acrylonitrile contents of 5 to 60, preferably 10 to 50 wt. % (NBR)

ethylene-propylene-diene copolymers (EPDM)

as well as mixtures of these rubbers.

In a preferred embodiment, the rubbers can be sulfur-curable.

Siliceous fillers and/or carbon black may be used as fillers.

Precipitated silicas or silicates may be used as siliceous fillers.

The carbon black used may be furnace black, gas black, channel black, lampblack, thermal black, acetylene black, plasma black, inversion carbon blacks, known from DE 195 21 565, Si-containing carbon blacks, known from WO 98/45361 or DE 19613796, or metal-containing carbon blacks, known from WO 98/42778, arc carbon black and carbon blacks which are the secondary products of chemical production processes. The carbon black can be activated by prior reactions, for example, oxidation. These references relating to carbon black are relied on and incorporated herein by reference.

1,7-dihydroxydipropyl ether, 2,6-dihydroxydipropyl ether or 3,5-dihydroxydipropyl ether can be used as processing agents.

The rubber compound may contain an organosilane.

The rubber compounds may contain 10 to 200 parts by weight of filler, 0.02 to 10 parts by weight of processing agent corresponding to formula I and optionally 0.02 to 10 parts by weight of organosilane, the parts by weight being based on 100 parts by weight of rubber.

The organosilane used can be an organosilicon compound corresponding to the general formula (II)

Z-Alk-Sₓ-Alk-Z (II),

wherein

Z denotes SiR¹R¹R², SiR¹R²R² or SiR²R²R², in which R¹ is a linear or branched carbon chain having 1-6 carbon atoms, a cycloalkane group having 5-12 carbon atoms, a benzyl group or a halogen- or alkyl-substituted phenyl group,

R² is an alkoxy group containing a linear or branched carbon chain having 1-6 C atoms, a cycloalkoxy group having 5-12 C atoms, a halogen- or alkyl-substituted phenoxy group or a benzyloxy group,

Alk denotes a divalent, saturated linear or branched C₁-C₁₀ hydrocarbon group, preferably methylene, ethylene, i-propylene, n-propylene, i-butylene, n-butylene, n-pentylene, 2-methylbutylene, 3-methylbutylene, 1,3-dimethylpropylene or 2,3-dimethylpropylene,

x is a number from 1 to 12, preferably 1 to 8, particularly preferably 2 to 6.

The organosilane used can be an organosilicon compound corresponding to the general formula (III)

X¹X²X³Si—A (III),

wherein

X¹, X², X³, independently of one another, are H, (C₁-C₁₂) alkyl, (C₁-C₈) alkoxy, (C₁-C₄) haloalkyl, aryl, (C₇-C₁₆) aralkyl, halogen or hydroxy,

A is straight-chain, branched or cyclic (C₁-C₁₈) alkyl, for example, methyl, ethyl, n-propyl, n-butyl, n-pentyl, n-hexyl, isopropyl or tert.-butyl, (C₁-C₅) alkoxy, for example, methoxy, ethoxy, propoxy, butoxy, isopropoxy, isobutoxy or pentoxy; halogen, for example, fluorine, chlorine, bromine or iodine; hydroxy, nitrile, (C₁-C₄) haloalkyl, NO₂, (C₁-C₈) thioalkyl, NH₂, NHR¹, NR¹R², alkenyl, aryl or (C₇-C₁₆) aralkyl.

Organosilanes particularly preferably used are:

bis(triethoxysilylpropyl)tetrasulfane

bis(triethoxysilylpropyl)disulfane

bis(trimethoxysilylpropyl)tetrasulfane or

bis(trimethoxysi lylpropyl)disulfane.

The rubber compounds according to the invention may contain additional known rubber auxiliaries such as, for example, cross-linking agents, vulcanization accelerators, reaction accelerators, reaction inhibitors, antioxidants, stabilizers, plasticizers, waxes, metal oxides, as well as activators, such as triethanolamine, polyethylene glycol, hexanetriol.

The rubber auxiliaries can be used in conventional quantities, which depend inter alia on the intended use. Conventional quantities are, for example, quantities of 0.1 to 50 wt. %, based on rubber.

Sulfur or organic sulfur donors can be used as cross-linking agents.

The rubber compounds according to the invention may in addition contain vulcanization accelerators. Examples of suitable vulcanization accelerators are mercaptobenzothiazoles, sulfenamides, guanidines, thiurams, dithiocarbamates, thioureas and thiocarbonates. The vulcanization accelerators and sulfur can be used in quantities of 0.1 to 10 wt. %, preferably 0.1 to 5 wt. %, based on the rubber used.

The invention also provides a process for producing the rubber compounds according to the invention, which is characterized in that the rubber or the mixture of rubbers, the filler and the processing agent corresponding to formula I are mixed in a mixing unit.

The mixing of the rubbers with the filler, with the processing agent corresponding to formula I and optionally the organosilane and other rubber auxiliaries can be carried out in conventional mixing units, such as rolls, closed mixers and mixer-extruders. Usually, such rubber compounds can be produced in closed mixers, with the rubbers, the filler, optionally the organosilanes and the rubber auxiliaries being first of all incorporated at 100 to 170° C. in one or more successive thermomechanical mixing steps. Here, the order of addition of the individual components and the time at which they are added may crucially affect the properties of the resulting mixture. Usually, the rubber compound thus obtained can be mixed with the cross-linking chemicals and with the processing agent corresponding to formula I in a closed mixer or on a roll at 40-110° C. and processed to form the so-called crude mixture for the subsequent processing steps such as, for example, forming and vulcanization.

The vulcanization of the rubber compounds according to the invention can be effected at temperatures of 80 to 200° C., preferably 130 to 180° C., optionally under a pressure of 10 to 200 bar.

The rubber compounds according to the invention can be used for producing mouldings, for example, for the production of pneumatic tires, tire treads, cable coverings, flexible tubes, drive belts, conveyor belts, roller coatings, tires, shoe soles, washers and damping elements.

The invention also provides mouldings obtainable by vulcanization from the rubber compound according to the invention.

The rubber compounds according to the invention have the advantage that the vulcanization time is shortened, ΔT_{center}, permanent set, viscosity and tan δ 60° C. (correlated with rolling resistance) are lowered and the reinforcement factor (modulus 300%/100%) and tan δ 0° C. (correlated with wet skid) are increased.

### EXAMPLES

The formulation used for the rubber compounds is given in Table 1. There the unit phr denotes parts by weight based on 100 parts of the crude rubber used. The general process for the production of rubber compounds and vulcanizates thereof is described in the following book: “Rubber Technology Handbook”, W. Hofmann, Hanser Verlag 1994.

TABLE 1

| | | | | | |
|---|---|---|---|---|---|
| | Com- | Com- | Com- | Com- | |
| | parison | parison | parison | parison | |
| | Example | Example | Example | Example | Example |
| | 1 | 2 | 3 | 4 | 1 |
| Substance | [phr] | [phr] | [phr] | [phr] | [phr] |

First step

| | | | | | |
|---|---|---|---|---|---|
| SMR 10 | 5 | 5 | 5 | 5 | 5 |
| BR | 20 | 20 | 20 | 20 | 20 |
| SBR | 111 | 111 | 111 | 111 | 111 |
| N 234 | 5 | 5 | 5 | 5 | 5 |
| Ultrasil 7000 GR | 60 | 60 | 60 | 60 | 60 |
| X 50 S | 9 | 9 | 9 | 9 | 9 |
| aromatic oil | 4 | 4 | 4 | 4 | 4 |
| Struktol A 60 | 3 | — | — | — | — |
| stearic acid HTI | 1 | 1 | 1 | 1 | 1 |
| Second step | | | | | |
| Batch step 1 | | | | | |
| Ultrasil 7000 GR | 25 | 25 | 25 | 25 | 25 |
| X 50 S | 4 | 4 | 4 | 4 | 4 |
| aromatic oil | 4 | 4 | 4 | 4 | 4 |
| Vulkanox 4020 | 2 | 2 | 2 | 2 | 2 |
| Vulkanox HS/LG | 2 | 2 | 2 | 2 | 2 |
| Antilux 654 | 1 | 1 | 1 | 1 | 1 |
| Struktol WB 212 | 2 | 2 | 1 | 1 | 1 |
| Wingstay 100 | 0.5 | 0.5 | 0.5 | 0.5 | 0.5 |
| Third step | | | | | |
| Batch step 2 | | | | | |
| 1,7-propanediol | — | 3 | — | — | — |
| trimethylol-propane | — | — | 3 | — | — |
| pentaerythritol | — | — | — | 3 | — |
| >98% | | | | | |
| 1,7-dihydroxy-dipropyl | — | — | — | — | 3 |
| ether | | | | | |
| ZnO | 3 | 3 | 3 | 3 | 3 |
| Vulkacit D | 2 | 2 | 2 | 2 | 2 |
| Vulkacit CZ/EG-C | 1.7 | 1.7 | 1.7 | 1.7 | 1.7 |
| Sulfur | 1.7 | 1.7 | 1.7 | 1.7 | 1.7 |

The polymer SMR 10 is natural rubber.
The polymer 1,4-polybutadiene (BR) is a polybutadiene having a cis 1,4 content of > 96% and extended with 37.5 parts oil.
The styrene-butadiene copolymer (SBR) is an oil-extended solution-SBR containing 37.5 parts oil and having a vinyl content of 20% and a styrene content of 34%.
The aromatic oil used is Naftolen ZD from Chemetall; Vulkanox 4020 is 6PPD and Vulkanox HS/LG is TMQ from Bayer AG. Struktol A 60 is a masticating agent, Struktol WB 212 is a processing agent from Schill + Seilacher, Vulkacit D (DPG) and Vulkacit CZ (CBS) are commercial products of Bayer AG. Antilux 654 is an antiozonant from Rhein-Chemie and Wingstay 100 is an antioxidant from Goodyear Chemicals.
Ultrasil 7000 GR is a readily dispersible precipitated silica from Degussa AG, having a BET surface area of 175 m²/g. The product X 50 S is a 1:1 mixture of Si 69 (Bis(triethoxysilyl-propyl)tetrasulfane) and of Corax N 330 from Degussa AG.

The rubber compounds are produced in a closed mixer, in accordance with the instructions for mixing given in Table 2.

TABLE 2
Step 1

Settings

| | |
|---|---|
| Mixing unit | Werner & Pfleiderer E Type |
| Speed | 60 min⁻¹ |
| Ram force | 5.5 bar |
| Empty volume | 1.58 L |
| Degree of filling | 0.56 |
| Temp. of flow | 70° C. |
| Mixing process | |
| 0 to 1 min | SMR 10 + SBR + BR |
| 1 to 3 min | carbon black, ½ silica, X 50 S, stearic acid, aromatic |
| | oil |
| 3 to 4 min | ½ silica, Struktol A 60 |
| 4 min | clean |
| 4 to 5 min | mix |
| 5 min | clean |
| 5 to 6 min | mix and draw out |
| Batch temp. | 145-150° C. |
| Storage | 24 h at room temperature |

Step 2

Settings

| | |
|---|---|
| Mixing unit | as in Step 1 except for: |
| Speed | 80 min⁻¹ |
| Temp. of flow | 80° C. |
| Degree of filling | 0.53 |
| Mixing process | |
| 0 to 2 min | break open Batch Step 1 |
| 2 to 4 min | silica, X 50 5, aromatic oil, Vulkanox 4020, Vulkanox |
| | HS/LG, Antilux 654, Struktol WB 212, Wingstay 100 |
| 4 to 5 min | mix |
| 5 min | draw out |
| Batch temp. | 150° C. |
| Storage | 4 h at room temperature |

Step 3

Settings

| | |
|---|---|
| Mixing unit | as in Step 1 except for: |
| Speed | 40 min⁻¹ |
| Degree of filling | 0.51 |
| Temp. of flow | 50° C. |
| Mixing process | |
| 0 to 2 min | Batch Step 2, accelerator, sulfur, ZnO, processing |
| | agent |
| 2 min | draw out and form sheet on laboratory mixing rolls |
| | (diameter 200 mm, length 450 mm, |
| | temperature of flow 50° C.) |
| | Homogenising: |
| | cut 3* left, 3* right and turn over, and pass through |
| | 8* with a wide roll nip (1 mm) and |
| | 3* with a narrow roll nip (3.5 mm) |
| | pull out the sheet. |
| Batch temp. | 85-95° C. |

The methods for testing the rubber are summarised in Table 3.

The mixtures are vulcanized for 30 minutes each at 168° C.

TABLE 3

| Physical testing | Standard/Conditions |
|---|---|
| ML 1 + 4, 100° C., Third step | DIN 53523/3, ISO 667 |
| Test using curemeter, 160° C. | DIN 53529/3, ISO 6502 |
| Dmax-Dmin [dNm] | |
| t 10% and t 95% [min] | |
| Tensile test on ring, 23° C. | DIN 53504, ISO 37 |
| tensile strength [MPa] | |
| modulus [MPa] | |
| elongation at break [%] | |
| Shore A hardness, 23° C. [−] | DIN 53 505 |
| Viscoelastic properties, | DIN 53 513 |
| 0 and 60° C., 16 Hz, 50 N front force | |
| and 25 N | |
| amplitude force | |
| Complexer module E* [MPa] | |
| dissipation factor tan δ [ ] | |
| Ball rebound, [%] | ASTM D 5308 |
| Goodrich flexometer test, | DIN 53533, ASTM D 623 A |
| 0.175 inch hub, 25 min, 23° C. | |
| Insertion temperature ΔT_{center} | |
| [° C.] | |
| Permanent set [%] | |
| Compression set [%] | |
| DIN abrasion, 10 N force [mm³] | DIN 53 516 |

Table 4 shows the results of the technical testing of the rubber.

TABLE 4

| | | | | | | |
|---|---|---|---|---|---|---|
| | | Com- | Com- | Com- | | |
| | | parison | parison | parison | Comparison | |
| Property | Unit | Example 1 | Example 2 | Example 3 | Example 4 | Example 1 |

Results for crude mixture

| | | | | | | |
|---|---|---|---|---|---|---|
| ML(1 + 4) at 100° C. | [−] | 86 | 78 | 76 | 108 | 74 |
| Dmax-Dmin (160° C.) | [Nm] | 6.6 | 8.4 | 7.9 | 10.6 | 9.9 |
| t 10% (160° C.) | [min] | 6.9 | 4.9 | 5.0 | 6.0 | 4.1 |
| t 95% (160° C.) | [min] | 26.4 | 19.5 | 25.1 | 31.9 | 13.7 |
| Results for vulcanisate | | | | | | |
| Tensile strength | [MPa] | 19.8 | 20.5 | 21.5 | 13.4 | 19.4 |
| Modulus 100% | [MPa] | 2.3 | 3.2 | 3.3 | 3.1 | 2.9 |
| Modulus 300% | [MPa] | 9.9 | 7.7 | 13.9 | — | 13 |
| Modulus 300%/100% | [−] | 4.3 | 2.4 | 4.2 | — | 4.5 |
| Elongation at break | [%] | 530 | 430 | 450 | 290 | 420 |
| Shore A hardness | [−] | 64 | 72 | 68 | 70 | 71 |
| Ball rebound (0° C.) | [%] | 11.1 | 12.1 | 11.0 | 10.6 | 10.8 |
| Ball rebound (60° C.) | [%] | 47.8 | 48.0 | 47.7 | 49.6 | 50.7 |
| Δ T_{center} Goodrich (RT, 25 min) | [° C.] | 106 | 88 | 88 | 100 | 81 |
| Permanent set | [%] | 7.8 | 4.7 | 3.2 | 3.3 | 2.6 |
| Compression set | [%] | 15.8 | 15.7 | 14.0 | 9.8 | 13.6 |
| DIN abrasion | [mm³] | 116 | 86 | 92 | 79 | 82 |
| E* 0° C. | [MPa] | 27.7 | 30.4 | 31.2 | 50.0 | 31.3 |
| E* 60° C. | [MPa] | 9.4 | 9.4 | 9.2 | 11.1 | 10.1 |
| Dissipation factor tan δ (0° C.) | [−] | 0.519 | 0.548 | 0.539 | 0.480 | 0.551 |
| Dissipation factor tan δ (60° C.) | [−] | 0.200 | 0.174 | 0.176 | 0.178 | 0.153 |

The data in Table 4 show that the rubber compound according to the invention, Example 1, has the lowest Mooney viscosity, the shortest t 95% vulcanization time, the greatest reinforcement factor (modulus 300%/100%), the lowest ΔT_{center} value and permanent set, the highest ball rebound value 60° C. and tan δ 0° C. value (improved wet skid) and the lowest tan δ 60° C. value (improved rolling resistance).

Further variations and modifications of the foregoing will be apparent to those skilled in the art and are intended to be encompassed by the claims appended hereto.

German priority application 101 30 500.1 of Jun. 25, 2001 is relied on and incorporated herein by reference.

We claim:

1. A rubber composition comprising
(a) a rubber or a mixture of rubbers,
(b) at least one filler and
(c) a processing agent corresponding to the general formula (I)
R¹—O—R² (I),
wherein R¹, R² may be identical or different and consist of hydroxy-substituted C₁ to C₈ alkyl groups, with the proviso that the hydroxy-substituted alkyl groups R¹ and R², separately or together, do not have a region containing at least 2 hydroxyl groups which are present as 1,2- or 1,3-diols.

2. The rubber composition according to claim 1, wherein the processing agent is 1,7-dihydroxydipropyl ether, 2,6-dihydroxydipropyl ether or 3,5-dihydroxydipropyl ether.

3. The rubber composition according to claim 1, wherein the rubber contains an organosilane.

4. The rubber composition according to claim 1, wherein the filler is at least one of a siliceous filler and carbon black.

5. A process for producing a rubber composition according to claim 1, comprising mixing together the rubber or the mixture of rubbers, the filler and the processing agent corresponding to formula I in a mixing unit.

6. A moulding made by vulcanizing the rubber composition according to claim 1.

7. A tire made from the rubber composition according to claim 1.
